(19) United States
(12) Patent Application Publication
(10) Pub. No.: US 2025/0326618 A1
(43) Pub. Date: Oct. 23, 2025

(54) FORKLIFT

(71) Applicant: MULTIWAY ROBOTICS TECHNOLOGY (SHENZHEN) CO., LTD., Shenzhen (CN)

(72) Inventors: Wencheng CHEN, Shenzhen (CN); Chaoshun LV, Shenzhen (CN)

(73) Assignee: MULTIWAY ROBOTICS TECHNOLOGY (SHENZHEN) CO., LTD., Shenzhen (CN)

(21) Appl. No.: 19/257,203

(22) Filed: Jul. 1, 2025

Related U.S. Application Data
(63) Continuation of application No. PCT/CN2022/133335, filed on Nov. 21, 2022.

(30) Foreign Application Priority Data
Oct. 8, 2022 (CN) 202222640300.9

(51) Int. Cl. B66F 9/22; B66F 9/075; B66F 9/08; B66F 9/12; B66F 9/20

(52) U.S. Cl. CPC B66F 9/22; B66F 9/07518; B66F 9/07531; B66F 9/0755; B66F 9/07568; B66F 9/08; B66F 9/122; B66F 9/205

(57) ABSTRACT

A forklift includes a vehicle body, a fork and a forward movement driving mechanism. The vehicle body includes a main body and two branch arms, the main body is provided with two ends opposite to each other, the two branch arms are respectively arranged at two ends of the main body and extend toward a rear of the vehicle body, the two branch arms are arranged opposite to each other and enclose with the main body to form an accommodating space, and a first mounting space is formed inside one of the branch arms. The fork is arranged in the accommodating space, the fork includes a first fork arm and a second fork arm, and the first fork arm is located above the second fork arm. The forward movement driving mechanism includes a first driving assembly and a second driving assembly.

### CROSS-REFERENCE TO RELATED APPLICATIONS

This application is a continuation application of International Application No. PCT/CN2022/133335, filed on Nov. 21, 2022, which claims priority to Chinese Patent Application No. 202222640300.9, filed on Oct. 8, 2022. All of the aforementioned applications are incorporated herein by reference in their entireties.

### TECHNICAL FIELD

The present application relates to the technical field of forklift, and in particular to a forklift.

### BACKGROUND

A forklift is a vehicle that uses a fork as a picking device and can lift goods to a certain height for transportation. At present, a conventional forklift has a mounting space formed inside thereof for mounting the internal assemblies of the forklift.

The internal assemblies are generally arranged randomly, resulting in a low utilization rate of the mounting space, which makes the forklift larger in size. In the process of warehousing and transportation, a wider aisle space needs to be designed for a larger forklift to allow the forklift to travel and turn. However, for warehousing and transportation, the increase in aisle space will lead to a decrease in the accommodating capacity, thereby failing to fully utilize the accommodating space of the warehouse.

### SUMMARY

The main purpose of this application is to provide a forklift, which aims to reduce the size of the forklift and increase the accommodating capacity by improving the utilization rate of the internal space of the forklift.

In order to achieve the above purpose, the present application provides a forklift, including:
a vehicle body including a main body and two branch arms, wherein the main body is provided with two ends opposite to each other, the two branch arms are respectively arranged at the two ends of the main body and extend toward a rear of the vehicle body, the two branch arms are arranged opposite to each other and enclose with the main body to form an accommodating space, and a first mounting space is formed inside one of the two branch arms;
a fork arranged in the accommodating space, wherein the fork includes a first fork arm and a second fork arm, and the first fork arm is located above the second fork arm;
a forward movement driving mechanism including a first driving assembly and a second driving assembly, wherein the first driving assembly and the second driving assembly are provided in the first mounting space in a stacked manner, and are respectively in transmission connection with the first fork arm and the second fork arm for driving the first fork arm and the second fork arm to move along a front-rear direction of the vehicle body;
an upper mast arranged in the accommodating space and connected to a movable end of the first driving assembly, and being configured to move the upper mast along the front-rear direction of the vehicle body under a drive of the first driving assembly, and the first fork arm being liftably arranged at the upper mast; and
a lower mast arranged in the accommodating space and located below the upper mast, the lower mast being connected to a movable end of the second driving assembly and being configured to move the lower mast along the front-rear direction of the vehicle body under a drive of the second driving assembly, and the second fork arm being liftably arranged at the lower mast.

In an embodiment, the upper mast is provided with a first sheave on a side facing the branch arm, the branch arm is provided with a first sliding groove on a side facing the upper mast, an end face of the first sheave is attached to a bottom wall of the first sliding groove, and the first sheave can slide along the side wall of the first sliding groove;
the lower mast is provided with a second sheave on a side facing the branch arm, the branch arm is provided with a second sliding groove on a side facing the lower mast, the second sliding groove is located below the first sliding groove, an end face of the second sheave is attached to a bottom wall of the second sliding groove, and the second sheave can slide along the side wall of the second sliding groove; and
the first mounting space extends from the main body to inner ends of the first sliding groove and the second sliding groove.

In an embodiment, a second mounting space is formed in the main body, and the second mounting space is in communication with the first mounting space; and
the forklift further includes a power mechanism arranged in the second mounting space and is configured to provide power for the first driving assembly and the second driving assembly.

In an embodiment, the first driving assembly is a first hydraulic oil cylinder, a movable end of the first hydraulic oil cylinder is connected to the upper mast; the second driving assembly is a second hydraulic oil cylinder, a movable end of the second hydraulic oil cylinder is connected to the lower mast;
the power mechanism includes:
a hydraulic pump arranged at a side of the second mounting space close to the first mounting space, oil pipes being connected between the first driving assembly and the hydraulic pump, and oil pipes being connected between the second driving assembly and the hydraulic pump;
an oil tank arranged at a side of the second mounting space away from the first mounting space and arranged opposite to the hydraulic pump, and oil pipes being connected between the hydraulic pump and the oil tank; and
a battery arranged in the second mounting space and is electrically connected to the hydraulic pump.

In an embodiment, the forklift also includes:
a steering wheel arranged at a bottom of the main body;
a driving motor arranged in the second mounting space and configured to control the turning of the steering wheel; and
a steering motor arranged in the second mounting space and configured to control the steering of the steering wheel;
wherein the driving motor and the steering motor are respectively in transmission connection with the steering wheel, and are respectively electrically connected to the battery.

In an embodiment, the battery, the driving motor and the steering motor are provided from top to bottom between the hydraulic pump and the oil tank in a stacked manner.

In an embodiment, an inner side of the branch arm away from the forward movement driving mechanism is formed with a third mounting space, and the third mounting space is in communication with the second mounting space;
the forklift further includes:
a third hydraulic oil cylinder arranged at the upper mast and configured to drive the first fork arm to ascend and descend along the upper mast;
a first oil pipe passed through the third mounting space, and two ends of the first oil pipe are respectively connected to the third hydraulic oil cylinder and the hydraulic pump;
a fourth hydraulic oil cylinder arranged at the lower mast and configured to drive the second fork arm to ascend and descend along the lower mast; and
a second oil pipe passed through the third mounting space, and two ends of the second oil pipe are respectively connected to the fourth hydraulic oil cylinder and the hydraulic pump.

In an embodiment, the upper mast includes:
an upper outer mast; and
an upper inner mast liftably arranged at an inner side of the upper outer mast, and the first fork arm being arranged at an inner side of the upper inner mast;
wherein the third hydraulic oil cylinder is arranged at the upper outer mast, a movable end of the third hydraulic oil cylinder is connected to the upper inner mast, and is configured to drive the upper inner mast to ascend and descend relative to the upper outer mast;
the lower mast includes:
a lower outer mast; and
a lower inner mast liftably arranged at an inner side of the lower outer mast, the second fork arm being arranged at an inner side of the lower inner mast;
wherein the fourth hydraulic oil cylinder is arranged at the lower outer mast, a movable end of the fourth hydraulic oil cylinder is connected to the lower inner mast, and is configured to drive the lower inner mast to ascend and descend relative to the lower outer mast.

In an embodiment, the forklift also includes:
a first sensor arranged at the upper mast and configured to detect obstacles outside the vehicle body and identify goods;
a first wire passed through the third mounting space and fixed at an outside of the first oil pipe, and two ends of the first wire being respectively connected to the first sensor and the battery;
a second sensor arranged at the lower mast and configured to detect obstacles outside the vehicle body and identify goods; and
a second wire passed through the third mounting space and fixed at an outside of the second oil pipe, and two ends of the second wire being respectively connected to the second sensor and the battery.

The forklift of the technical solution of the present application includes a vehicle body, a fork and a forward movement driving mechanism, the vehicle body includes a main body and two branch arms, and the main body and the two branch arms enclose to form an accommodating space; a first mounting space is formed inside one of the two branch arms, and the first mounting space is located inside the main body; a first through hole communicating the first mounting space with the accommodating space is opened on the surface of the main body, and a first driving assembly and a second driving assembly can extend from the first through hole to the first mounting space to respectively drive the first fork arm and the second fork arm located in the accommodating space to move along the front-rear direction of the vehicle body. The first driving assembly and the second driving assembly are provided in a stacked manner, and the first driving assembly is located above the second driving assembly. The arrangement of the first driving assembly and the second driving assembly on the same side in the present solution can effectively reduce the width of the vehicle body, thereby improving the utilization rate of the internal space of the vehicle body, so as to reduce the mounting space reserved for setting the first driving assembly and the second driving assembly, thereby reducing the volume of the forklift. The forklift with reduced volume can adapt to the narrower lane space, thereby improving the accommodating capacity rate.

### BRIEF DESCRIPTION OF THE DRAWINGS

In order to illustrate the technical solutions in the embodiments of the present application or in the related art more clearly, the following briefly introduces the accompanying drawings required for the description of the embodiments or the related art. Obviously, the drawings in the following description are only part of embodiments of the present application. For those skilled in the art, other drawings can also be obtained according to the structures shown in these drawings without any creative effort.

FIG. 1 is a cross-sectional view of a forklift according to an embodiment of the present application.

FIG. 2 is a schematic structural view of a forklift according to an embodiment of the present application.

FIG. 3 is a schematic structural view of a forklift according to an embodiment of the present application.

FIG. 4 is a schematic structural view of a forklift according to an embodiment of the present application.

The realization of the objective, functional characteristics, and advantages of the present application are further described with reference to the accompanying drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all of the embodiments of the present application. All other embodiments obtained by persons skilled in the art based on the embodiments of the present application without creative efforts shall fall within the scope of the present application.

It should be noted that if there are directional indications, such as up, down, left, right, front, back, etc., involved in the embodiments of the present application, the directional indications are only used to explain a certain posture as shown in the accompanying drawings. If the specific posture changes, the directional indication also changes accordingly

In the present application, unless otherwise specifically stated and limited, the terms “connected”, “fixed”, etc. should be interpreted expansively. For example, “fixed” may be fixed connection, also may be detachable connection, or integration; may be mechanical connection, also may be electrical connection; may be direct connected, also may be indirect connected through an intermediate medium, and may be internal communication between two elements or interaction of two elements, unless otherwise specifically defined. The ordinary skill in this field, can understand the specific meanings of the above terms in the present application according to the specific condition.

In addition, if there are descriptions related to “first”, “second”, etc. in the embodiments of the present application, the descriptions of “first”, “second”, etc. are only for the purpose of description, and should not be construed as indicating or implying relative importance or implicitly indicates the number of technical features indicated. Thus, a feature delimited with “first”, “second” may expressly or implicitly include at least one of that feature. Besides, the meaning of “and/or” appearing in the application includes three parallel scenarios. For example, “A and/or B” includes only A, or only B, or both A and B. In addition, the technical solutions between the various embodiments can be combined with each other, but must be based on the realization by those skilled in the art. When the combination of technical solutions is contradictory or cannot be realized, it should be considered that the combination of such technical solutions does not exist or fall within the scope of protection claimed in the present application.

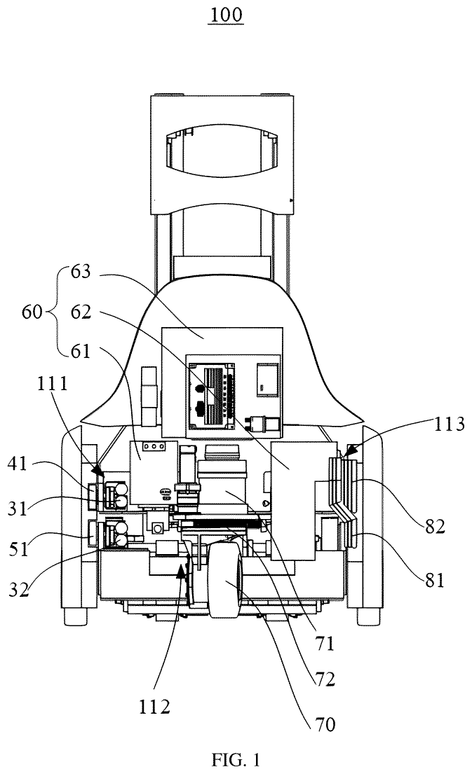

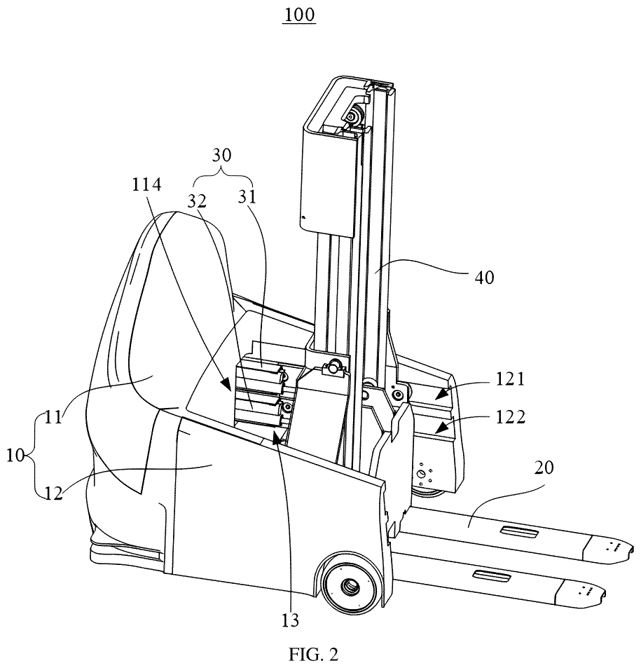

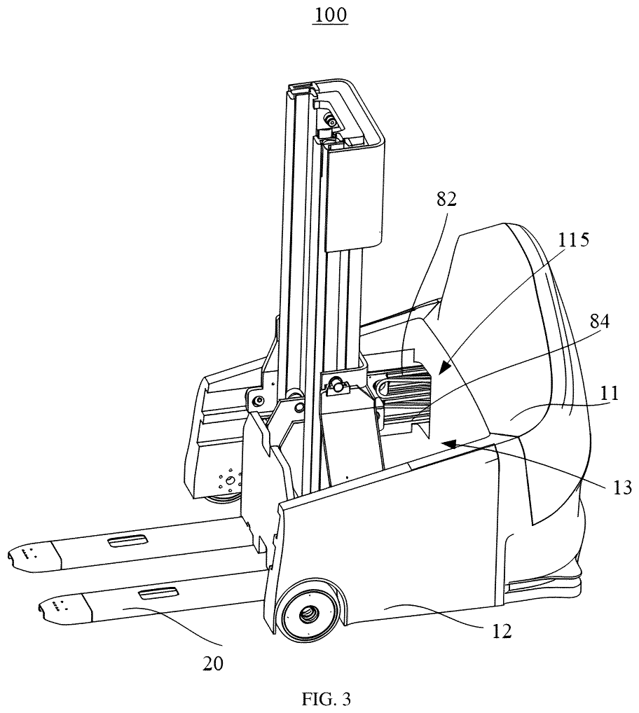

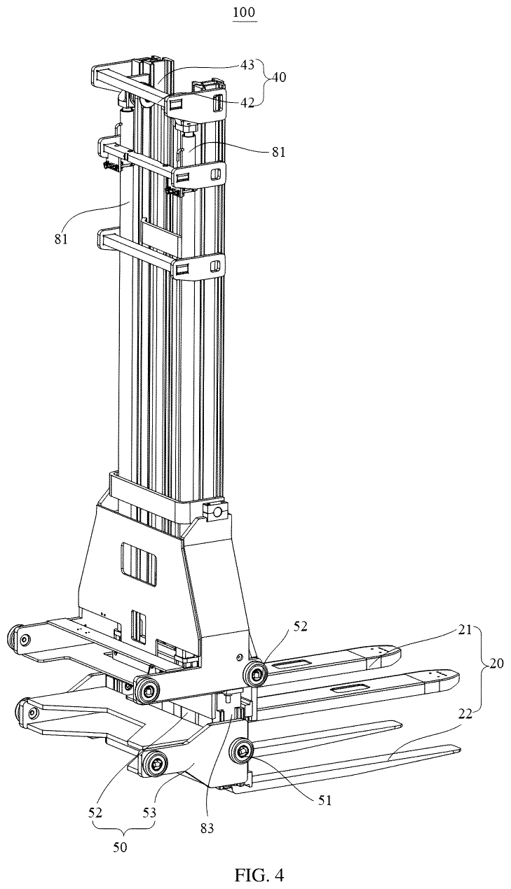

Referring to FIG. 1 to FIG. 4, the present application provides a forklift 100, including: a vehicle body 10, a fork 20 and a forward movement driving mechanism 30.

The vehicle body 10 includes a main body 11 and two branch arms 12, the main body 11 is provided with two ends opposite to each other, the two branch arms 12 are respectively arranged at two ends of the main body 11 and extend toward a rear of the vehicle body 10, the two branch arms 12 are arranged opposite to each other and enclose with the main body 11 to form an accommodating space 13, and a first mounting space 111 is formed inside one of the branch arms 12.

The fork 20 is arranged in the accommodating space 13, the fork 20 includes a first fork arm 21 and a second fork arm 22, and the first fork arm 21 is located above the second fork arm 22.

The forward movement driving mechanism 30 includes a first driving assembly 31 and a second driving assembly 32, the first driving assembly 31 and the second driving assembly 32 are provided in the first mounting space 111 in a stacked manner, and are respectively in transmission connection with the first fork arm 21 and the second fork arm 22 for driving the first fork arm 21 and the second fork arm 22 to move along the front-rear direction of the vehicle body 10.

The forklift 100 of the technical solution of the present application includes a vehicle body 10, a fork 20 and a forward movement driving mechanism 30 the vehicle body 10 includes a main body 11 and two branch arms 12, and the main body 11 and the two branch arms 12 enclose to form an accommodating space 13; a first mounting space 111 is formed inside one of the two branch arms 12, and the first mounting space 111 is located inside the main body 11; a first through hole 114 communicating the first mounting space 111 with the accommodating space 13 is opened on the surface of the main body 11, and a first driving assembly 31 and a second driving assembly 32 can extend out of the first mounting space 111 from the first through hole 114 to respectively drive the first fork arm 21 and the second fork arm 22 located in the accommodating space 13 to move along the front-rear direction of the vehicle body 10. The first driving assembly 31 and the second driving assembly 32 are provided in a stacked manner, and the first driving assembly 31 is located above the second driving assembly 32. The arrangement of the first driving assembly 31 and the second driving assembly 32 on the same side in the present solution can effectively reduce the width of the vehicle body 10, thereby improving the utilization rate of the internal space of the vehicle body 10, so as to reduce the mounting space reserved for the first driving assembly 31 and the second driving assembly 32, thereby reducing the volume of the forklift 100. The forklift 100 with reduced volume can adapt to the narrower lane space, thereby improving the accommodating capacity.

The vehicle body 10 also includes an upper mast 40 and a lower mast 50, and the first fork arm 21 and the second fork arm 22 can ascend and descend along the upper mast 40 and the lower mast 50 respectively; the first driving assembly 31 and the second driving assembly 32 can be a cylinder, a hydraulic oil cylinder, or a motor, and the type and structure of the first driving assembly 31 and the second driving assembly 32 are not limited here.

The vehicle body 10 structure of the main body 11 and the two branch arms 12 can make the forklift 100 extend the fork 20 from the accommodating space 13 to pick up the goods when the forklift 100 picks up the goods; when the forklift 100 is transporting, the fork 20 is retracted into the accommodating space 13, thereby effectively reducing the length of the vehicle body 10 and reducing the volume of the forklift 100. The forklift 100 with a reduced volume can adapt to a narrower lane space, thereby improving the accommodating capacity.

Referring to FIG. 1 to FIG. 4, in an embodiment of the present application, the forklift 100 also includes: an upper mast 40 and a lower mast 50.

The upper mast 40 is arranged in the accommodating space 13 and connected to the movable end of the first driving assembly 31, and is configured to move the upper mast 40 along the front-rear direction of the vehicle body 10 under the drive of the first driving assembly 31, and the first fork arm 21 is liftably arranged at the upper mast 40.

The lower mast 50 is arranged in the accommodating space 13 and is located below the upper mast 40, the lower mast 50 is connected to the movable end of the second driving assembly 32 and is configured to move the lower mast 50 along the front-rear direction of the vehicle body 10 under the driving of the second driving assembly 32, and the second fork arm 22 is liftably arranged at the lower mast 50.

In the technical solution of one embodiment of the present application, the first fork arm 21 can ascend and descend along the upper mast 40, and the second fork arm 22 can ascend and descend along the lower mast 50. The movable end of the first driving assembly 31 is connected to the upper mast 40 for driving the upper mast 40 to move along the front-rear direction of the vehicle body 10, and the first fork arm 21 can move along the front-rear direction of the vehicle body 10 with the upper mast 40.

The movable end of the second driving assembly 32 is connected to the lower mast 50 for driving the lower mast 50 to move along the front-rear direction of the vehicle body 10, and the second fork arm 22 can move along the front-rear direction of the vehicle body 10 with the lower mast 50.

Referring to FIG. 1 to FIG. 4, in an embodiment of the present application, the upper mast 40 is provided with a first sheave 41 on the side facing the branch arm 12, and the branch arm 12 is provided with a first sliding groove 121 on the side facing the upper mast 40; the end surface of the first sheave 41 is attached to the bottom wall of the first sliding groove 121, and the first sheave 41 can slide along the side wall of the first sliding groove 121.

The lower mast 50 is provided with a second sheave 51 on the side facing the branch arm 12, and the branch arm 12 is provided with a second sliding groove 122 on the side facing the lower mast 50; the second sliding groove 122 is located below the first sliding groove 121, the end surface of the second sheave 51 is attached to the bottom wall of the second sliding groove 122, and the second sheave 51 can slide along the side wall of the second sliding groove 122.

The first mounting space 111 extends from the main body 11 to the inner ends of the first sliding groove 121 and the second sliding groove 122.

In the technical solution of the present application, the upper mast 40 is slidably connected to the first sliding groove 121 of the branch arm 12 through the first sheave 41, and both sides of the upper mast 40 are provided with a first sheave 41; the end faces of the first sheaves 41 on both sides of the upper mast 40 are attached to the bottom wall of the first sliding groove 121, which plays a role in supporting the upper mast 40. At the same time, since the first sheave 41 can slide along the side wall of the first sliding groove 121, the friction between the upper mast 40 and the branch arm 12 is reduced, which makes it easier for the first driving assembly 31 to push the upper mast 40 to move along the front-rear direction of the vehicle body 10.

The lower mast 50 is slidably connected to the second sliding groove 122 of the branch arm 12 through the second sheave 51, and both sides of the lower mast 50 is provided with a second sheave 51; the end faces of the second sheaves 51 on both sides of the lower mast 50 are attached to the bottom wall of the second sliding groove 122, which plays a role in supporting the lower mast 50. At the same time, since the second sheave 51 can slide along the side wall of the second sliding groove 122, the friction between the lower mast 50 and the branch arm 12 is reduced, which makes it easier for the second driving assembly 32 to push the lower mast 50 to move along the front-rear direction of the vehicle body 10.

Referring to FIG. 1 to FIG. 4, in an embodiment of the present application, a second mounting space 112 is formed in the main body 11, and the second mounting space 112 is in communication with the first mounting space 111.

The forklift 100 also includes a power mechanism 60, the power mechanism 60 is arranged in the second mounting space 112 and is configured to provide power for the first driving assembly 31 and the second driving assembly 32.

In the technical solution of the present application, the second mounting space 112 is located at one side of the first mounting space 111, and the second mounting space 112 is provided with a power mechanism 60, which is configured to provide power for the first driving assembly 31 and the second driving assembly 32 in the first mounting space 111. When the first driving assembly 31 and the second driving assembly 32 are cylinders, the power mechanism 60 is an air compressor; when the first driving assembly 31 and the second driving assembly 32 are hydraulic oil cylinders, the power mechanism 60 is an oil tank 62 and an oil pump; when the first driving assembly 31 and the second driving assembly 32 are motors, the power mechanism 60 is a battery 63. The type and structure of the power mechanism 60 are not limited here.

Referring to FIG. 1 to FIG. 4, in an embodiment of the present application, the first driving assembly 31 is a first hydraulic oil cylinder, and the movable end of the first hydraulic oil cylinder is connected to the upper mast 40; the second driving assembly 32 is a second hydraulic oil cylinder, and the movable end of the second hydraulic oil cylinder is connected to the lower mast 50.

The power mechanism 60 includes: a hydraulic pump 61, an oil tank 62 and a battery 63.

The hydraulic pump 61 is arranged at the side of the second mounting space 112 close to the first mounting space 111, oil pipes are connected between the first driving assembly 31 and the hydraulic pump 61, and oil pipes are connected between the second driving assembly 32 and the hydraulic pump 61.

The oil tank 62 is arranged at the side of the second mounting space 112 away from the first mounting space 111 and is arranged opposite to the hydraulic pump 61, and oil pipes is connected between the hydraulic pump 61 and the oil tank 62.

The battery 63 is arranged in the second mounting space 112, and is electrically connected to the hydraulic pump 61.

In the technical solution of the present application, when the first driving assembly 31 and the second driving assembly 32 are hydraulic oil cylinders, the movable ends of the first driving assembly 31 and the second driving assembly 32 are connected to the upper mast 40 and the lower mast 50 respectively.

The power mechanism 60 includes an oil tank 62, a hydraulic pump 61 and a battery 63, and oil pipes are connected between the hydraulic pump 61 and the oil tank 62, between the hydraulic pump 61 and the first driving assembly 31, and between the hydraulic pump 61 and the second driving assembly 32. The battery 63 supplies power to the hydraulic pump 61, and the hydraulic pump 61 extracts the hydraulic oil from the oil tank 62 through the oil pipe, and then pumps the hydraulic oil to the first driving assembly 31 and the second driving assembly 32 through the oil pipe, so that the movable ends of the first driving assembly 31 and the second driving assembly 32 move along the front-rear direction of the vehicle body 10, thereby driving the upper mast 40, the first fork arm 21 and the lower mast 50, and the second fork arm 22 to move along the front-rear direction of the vehicle body 10.

Referring to FIG. 1 to FIG. 4, in an embodiment of the present application, the forklift 100 further includes: a steering wheel 70, a driving motor and a steering motor 72.

The steering wheel 70 is arranged at the bottom of the main body 11.

The driving motor 71 is arranged in the second mounting space 112 and is configured to control the rotation of the steering wheel 70.

The steering motor 72 is arranged in the second mounting space 112 and is configured to control the steering of the steering wheel 70.

The driving motor 71 and the steering motor 72 are respectively in transmission connection with the steering wheel 70, and are respectively electrically connected to the battery 63.

In the technical solution of the present application, the steering wheel 70 is a vertical steering wheel 70, the driving motor 71 and the steering motor 72 are respectively connected to the steering wheel 70; a number of transmission members are provided between the travel motor 71, the steering motor 72 and the steering wheel 70, and the output shaft of the travel motor 71 controls the turning speed of the steering wheel 70 to control the forward movement speed of the vehicle body 10; the output shaft of the steering motor 72 controls the orientation of the steering wheel 70 by turning to control the forward movement direction of the vehicle body 10.

In addition to the steering wheel 70, the vehicle body 10 is also provided with a load-bearing wheel, the load-bearing wheel is arranged at one end of the two branch arms 12 away from the main body 11, and is configured to assist in supporting the vehicle body 10.

Referring to FIG. 1 to FIG. 4, in an embodiment of the present application, the battery 63, the driving motor 71 and the steering motor 72 are provided from top to bottom between the hydraulic pump 61 and the oil tank 62 in a stacked manner.

In the technical solution of the present application, the steering wheel 70 is located in the middle of the chassis. In order to further optimize the internal structure of the vehicle body 10, the battery 63, the driving motor 71 and the steering motor 72 are provided from top to bottom in the middle of the second mounting space 112 in a stacked manner, that is, between the oil tank 62 and the hydraulic pump 61, so as to maximize the use of the internal space of the vehicle body 10, thereby reducing the width of the vehicle body 10 and the volume of the forklift 100 to improve the accommodating capacity.

Referring to FIG. 1 to FIG. 4, in an embodiment of the present application, the inner side of the branch arm 12 away from the forward movement driving mechanism 30 is formed with a third mounting space 113, and the third mounting space 113 is in communication with the second mounting space 112.

The forklift 100 also includes a third hydraulic oil cylinder 81, a first oil pipe 82, a fourth hydraulic oil cylinder 83 and a second oil pipe 84.

The third hydraulic oil cylinder 81 is arranged at the upper mast 40, and is configured to drive the first fork arm 21 to ascend and descend along the upper mast 40.

The first oil pipe 82 is passed through the third mounting space 113, and the two ends of the first oil pipe 82 are respectively connected to the third hydraulic oil cylinder 81 and the hydraulic pump 61.

The fourth hydraulic oil cylinder 83 is arranged at the lower mast 50, and is configured to drive the second fork arm 22 to ascend and descend along the lower mast 50.

The second oil pipe 84 is passed through the third mounting space 113, and the two ends of the second oil pipe 84 are respectively connected to the fourth hydraulic oil cylinder 83 and the hydraulic pump 61.

In the technical solution of the present application, the first fork arm 21 and the second fork arm 22 are respectively liftably arranged at the upper mast 40 and the lower mast 50.

In order to drive the first fork arm 21 to ascend and descend along the upper mast 40, the upper mast 40 is provided with a third hydraulic oil cylinder 81, and the movable end of the third hydraulic oil cylinder 81 is connected to the first fork arm 21 for driving the first fork arm 21 to ascend and descend, and the third hydraulic oil cylinder 81 is connected to the hydraulic pump 61 through the first oil pipe 82, so that the power mechanism 60 provides power for the third hydraulic oil cylinder 81.

In order to drive the second fork arm 22 to ascend and descend along the lower mast 50, and the lower mast 50 is provided with a fourth hydraulic oil cylinder 83, the movable end of the fourth hydraulic oil cylinder 83 is connected to the second fork arm 22 to drive the second fork arm 22 to ascend and descend, and the fourth hydraulic oil cylinder 83 is connected to the hydraulic pump 61 through the second oil pipe 84, so that the power mechanism 60 provides power for the fourth hydraulic oil cylinder 83.

The inner side of the branch arm 12 is formed with a third mounting space 113, and the third mounting space 113 is located inside the main body 11. The surface of the main body 11 is provided with a second through hole 115 communicating the third mounting space 113 with the accommodating space 13, and the first through hole 114 and the second through hole 115 are respectively located at both ends of the main body 11. The first oil pipe 82 and the second oil pipe 84 can extend from the second through hole 115 to the third mounting space 113 to communicate the hydraulic pump 61 with the third hydraulic oil cylinder 81 and the fourth hydraulic oil cylinder 83, respectively. The regular wiring of the first oil pipe 82 and the second oil pipe 84 can effectively reduce the width of the vehicle body 10, thereby improving the utilization rate of the internal space of the vehicle body 10, so as to reduce the mounting space reserved for setting the first oil pipe 82 and the second oil pipe 84 in the existing scheme, thereby reducing the volume of the forklift 100. The forklift 100 with reduced volume can adapt to the narrower lane space, thereby improving the accommodating capacity.

Referring to FIG. 1 to FIG. 4, in an embodiment of the present application, the upper mast 40 includes: an upper outer mast 42 and an upper inner mast 43.

The upper inner mast 43 can be liftably arranged at the inner side of the upper outer mast 42, and the first fork arm 21 is arranged at the inner side of the upper inner mast 43.

The third hydraulic oil cylinder 81 is arranged at the upper outer mast 42, and the movable end of the third hydraulic oil cylinder 81 is connected to the upper inner mast 43, which is configured to drive the upper inner mast 43 relative to the the upper outer mast 42 to ascend and descend.

The lower mast 50 includes: a lower outer mast 52 and a lower inner mast 53.

The lower inner mast 53 is liftably arranged at the inner side of the lower outer mast 52, and the second fork arm 22 is arranged at the inner side of the lower inner mast 53.

The fourth hydraulic oil cylinder 83 is arranged at the lower outer mast 52, and the movable end of the fourth hydraulic oil cylinder 83 is connected to the lower inner mast 53, which is configured to drive the lower inner mast 53 to ascend and descend relative to the lower outer mast 52.

In the technical solution of the present application, the third hydraulic oil cylinder 81 is fixed at the upper outer mast 42, and the movable end of the third hydraulic oil cylinder 81 is connected to the upper inner mast 43 to drive the upper inner mast 43 to ascend and descend, thereby driving the first fork arm 21 connected to the upper inner mast 43 to ascend and descend.

The fourth hydraulic oil cylinder 83 is fixed at the lower outer mast 52, and the movable end of the fourth hydraulic oil cylinder 83 is connected to the lower inner mast 53 to drive the lower inner mast 53 to ascend and descend, thereby driving the second fork arm 22 connected to the lower inner mast 53 to ascend and descend.

Referring to FIG. 1 to FIG. 4, in an embodiment of the present application, the forklift 100 also includes: a first sensor, a first wire, a second sensor and a second wire.

The first sensor is arranged at the upper mast 40 and is configured to detect obstacles outside the vehicle body 10 and identify goods.

The first wire is passed through the third mounting space 113 and fixed at the outside of the first oil pipe 82, and the two ends of the first wire are respectively connected to the first sensor and the battery 63.

The second sensor is arranged at the lower mast 50 and is configured to detect obstacles outside the vehicle body 10 and identify goods.

The second wire is passed through the third mounting space 113 and fixed at the outside of the second oil pipe 84, and the two ends of the second wire are respectively connected to the second sensor and the battery 63.

In the technical solution of the present application, the first sensor and the second sensor can be photoelectric switches for detecting obstacles in front of the upper mast 40 and the lower mast 50; they can also be obstacle avoidance radars for detecting obstacles in front of the upper mast 40 and the lower mast 50; they can also be obstacle avoidance cameras for identifying goods in front of the upper mast 40 and the lower mast 50. The types and structures of the first sensor and the second sensor are not limited here.

The first wire and the second wire are respectively passed through the second through hole 115 and passed through the third mounting space 113. In order to avoid the first wire and the second wire from being entangled or interfering with each other, the first wire and the second wire are respectively fixed at the outside of the first oil pipe 82 and the second oil pipe 84 through the fixing parts, thereby optimizing the wiring method of the first wire and the second wire, which can effectively reduce the width of the vehicle body 10, thereby improving the utilization rate of the internal space of the vehicle body 10, so as to reduce the mounting space reserved for setting the first wire and the second wire in the existing scheme, thereby reducing the volume of the forklift 100. The forklift 100 with reduced volume can adapt to the narrower lane space, thereby improving the accommodating capacity rate.

The above descriptions are only embodiments of the present application, and are not intended to limit the scope of the present application. Under the inventive concept of the present application, any equivalent structural transformations made by using the contents of the description and drawings of the present application, or direct/indirect applications in other related technical fields are included in the scope of the present application.

What is claimed is:

1. A forklift, comprising:
a vehicle body comprising a main body and two branch arms, wherein the main body is provided with two ends opposite to each other, the two branch arms are respectively arranged at the two ends of the main body and extend toward a rear of the vehicle body, the two branch arms are arranged opposite to each other and enclose with the main body to form an accommodating space, and a first mounting space is formed inside one of the two branch arms;
a fork arranged in the accommodating space, wherein the fork comprises a first fork arm and a second fork arm, and the first fork arm is located above the second fork arm;
a forward movement driving mechanism comprising a first driving assembly and a second driving assembly, wherein the first driving assembly and the second driving assembly are provided in the first mounting space in a stacked manner, and are respectively in transmission connection with the first fork arm and the second fork arm for driving the first fork arm and the second fork arm to move along a front-rear direction of the vehicle body;
an upper mast arranged in the accommodating space and connected to a movable end of the first driving assembly, and being configured to move the upper mast along the front-rear direction of the vehicle body under a drive of the first driving assembly, and the first fork arm being liftably arranged at the upper mast; and
a lower mast arranged in the accommodating space and located below the upper mast, the lower mast being connected to a movable end of the second driving assembly and being configured to move the lower mast along the front-rear direction of the vehicle body under a drive of the second driving assembly, and the second fork arm being liftably arranged at the lower mast.

2. The forklift according to claim 1, wherein the upper mast is provided with a first sheave on a side facing the branch arm, the branch arm is provided with a first sliding groove on a side facing the upper mast, an end face of the first sheave is attached to a bottom wall of the first sliding groove, and the first sheave is capable of sliding along the side wall of the first sliding groove;
the lower mast is provided with a second sheave on a side facing the branch arm, the branch arm is provided with a second sliding groove on a side facing the lower mast, the second sliding groove is located below the first sliding groove, an end face of the second sheave is attached to a bottom wall of the second sliding groove, and the second sheave is capable of sliding along the side wall of the second sliding groove; and
the first mounting space extends from the main body to inner ends of the first sliding groove and the second sliding groove.

3. The forklift according to claim 1, wherein a second mounting space is formed in the main body, and the second mounting space is in communication with the first mounting space; and
the forklift further comprises a power mechanism arranged in the second mounting space and is configured to provide power for the first driving assembly and the second driving assembly.

4. The forklift according to claim 3, wherein the first driving assembly is a first hydraulic oil cylinder, a movable end of the first hydraulic oil cylinder is connected to the upper mast; the second driving assembly is a second hydraulic oil cylinder, a movable end of the second hydraulic oil cylinder is connected to the lower mast;
the power mechanism comprises:
a hydraulic pump arranged at a side of the second mounting space close to the first mounting space, oil pipes being connected between the first driving assembly and the hydraulic pump, and oil pipes being connected between the second driving assembly and the hydraulic pump;
an oil tank arranged at a side of the second mounting space away from the first mounting space and arranged opposite to the hydraulic pump, and oil pipes being connected between the hydraulic pump and the oil tank; and
a battery arranged in the second mounting space and is electrically connected to the hydraulic pump.

5. The forklift according to claim 4, further comprising:
a steering wheel arranged at a bottom of the main body;
a driving motor arranged in the second mounting space and configured to control the turning of the steering wheel; and
a steering motor arranged in the second mounting space and configured to control the steering of the steering wheel;
wherein the driving motor and the steering motor are respectively in transmission connection with the steering wheel, and are respectively electrically connected to the battery.

6. The forklift according to claim 5, wherein the battery, the driving motor and the steering motor are provided from top to bottom between the hydraulic pump and the oil tank in a stacked manner.

7. The forklift according to claim 4, wherein an inner side of the branch arm away from the forward movement driving mechanism is formed with a third mounting space, and the third mounting space is in communication with the second mounting space;
the forklift further comprises:
a third hydraulic oil cylinder arranged at the upper mast and configured to drive the first fork arm to ascend and descend along the upper mast;
a first oil pipe passed through the third mounting space, and two ends of the first oil pipe are respectively connected to the third hydraulic oil cylinder and the hydraulic pump;
a fourth hydraulic oil cylinder arranged at the lower mast and configured to drive the second fork arm to ascend and descend along the lower mast; and
a second oil pipe passed through the third mounting space, and two ends of the second oil pipe are respectively connected to the fourth hydraulic oil cylinder and the hydraulic pump.

8. The forklift according to claim 7, wherein the upper mast comprises:
an upper outer mast; and
an upper inner mast liftably arranged at an inner side of the upper outer mast, and the first fork arm being arranged at an inner side of the upper inner mast;
wherein the third hydraulic oil cylinder is arranged at the upper outer mast, a movable end of the third hydraulic oil cylinder is connected to the upper inner mast, and is configured to drive the upper inner mast to ascend and descend relative to the upper outer mast;
the lower mast comprises:
a lower outer mast; and
a lower inner mast liftably arranged at an inner side of the lower outer mast, the second fork arm being arranged at an inner side of the lower inner mast;
wherein the fourth hydraulic oil cylinder is arranged at the lower outer mast, a movable end of the fourth hydraulic oil cylinder is connected to the lower inner mast, and is configured to drive the lower inner mast to ascend and descend relative to the lower outer mast.

9. The forklift according to claim 7, further comprising:
a first sensor arranged at the upper mast and configured to detect obstacles outside the vehicle body and identify goods;
a first wire passed through the third mounting space and fixed at an outside of the first oil pipe, and two ends of the first wire being respectively connected to the first sensor and the battery;
a second sensor arranged at the lower mast and configured to detect obstacles outside the vehicle body and identify goods; and
a second wire passed through the third mounting space and fixed at an outside of the second oil pipe, and two ends of the second wire being respectively connected to the second sensor and the battery.
